(19) United States
(12) Patent Application Publication
(10) Pub. No.: US 2008/0278911 A1
(43) Pub. Date: Nov. 13, 2008

(54) Cooling fan and dynamic pressure bearing structure

(76) Inventors: Wen-Pin Chen, Hukou Township (TW); Sheng-Pin Su, Hukou Township (TW); Zhen-Yu Lee, Hukou Township (TW); Meng-Jia Tsai, Hukou Township (TW); Mei-Lin Lai, Hukou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,193

(22) Filed: May 11, 2007

(51) Int. Cl. B23P 17/00

(52) U.S. Cl. 361/695

(57) ABSTRACT

A cooling fan and dynamic pressure bearing structure is disclosed. The cooling fan includes a base portion, a bearing portion, a dynamic pressure bearing, a coil assembly, and an impeller assembly. The dynamic pressure bearing is received in the bearing portion. A plurality of pressure collecting grooves is arranged in an inner surface of a shaft hole of the dynamic pressure bearing at intervals for receiving lubricating oil. Each pressure collecting groove has two slanted grooves extending slantways which connect with each other at one end to form a connecting point. A transverse groove extends from the connecting point backward the direction of the two slanted grooves. Based on the special design of the pressure collecting groove, the present invention increases the area that creates pressure to increase the intensity of the pressure and decrease the number of pressure collecting grooves to reduce processing loads and production costs.

### BACKGROUND OF THE INVENTION

1. Field of the Invention

The present invention relates to a cooling fan and dynamic pressure bearing structure, and particularly to a hydrodynamic pressure bearing may increase the intensity of pressure by increasing the area that creates pressure and reduces the processing load and costs of production by decreasing the number of pressure collecting grooves.

2. Description of the Prior Art

Lubricating oil in hydrodynamic may lubricate the shaft and bearing in order to avoid collisions and damage of the bearing. Prior hydrodynamic bearings classify as static pressure bearing and dynamic pressure bearing.

Lubricating oil is stored inside static pressure bearing at room temperature. When the static pressure bearing is rotating, the shaft can be supported due to the liquid pressure caused by the lubricating oil. If the shaft is deviated, the lubricating oil presses on the deviating side to move the shaft back to the correct position. In this method, the static pressure bearings need to match with external systems to exert pressure, so these are usually used in large-scale mechanical equipments.

Dynamic pressure bearings are usually used in small-scale motors (such as cooling fans). Based upon the fluid characteristics within these narrow pressure collecting grooves, when the shaft is rotating the lubricating oil is drawn in the pressure collecting grooves to create dynamic pressure in order to support the shafts in the center of the bearings.

These pressure collecting grooves of the prior dynamic pressure bearings have a “<” shape. When the shaft is rotating, the lubricating oil in the pressure collecting grooves flows along the pressure collecting grooves and the oil is moving centralized into the centers of the pressure collecting grooves to induce dynamic pressure. The pressure building-up is limited to the center area of the pressure collecting grooves (i.e. the turning points of the pressure collecting grooves with a “<” shape), so the intensity of pressure built up is relatively low due to the small area. As such, there are more pressure collecting grooves are requested for the prior dynamic pressure bearings to achieve the predetermined intensity of pressure, so that it makes the producing more complicated and increases the cost.

Hence, the inventors of the present invention believe that the shortcomings described above are able to be improved and finally suggest the present invention which is of a reasonable design and is an effective improvement based on deep research and thought.

### SUMMARY OF THE INVENTION

An object of the present invention is to provide a cooling fan and dynamic pressure bearing structure with less number of pressure collecting grooves of the dynamic pressure bearing to reduce the processing load and production costs.

To achieve the above-mentioned object, a cooling fan in accordance with the present invention is disclosed. The cooling fan includes a base portion; a bearing portion having a internal storage space and the bearing portion is being fixed on the base portion; a dynamic pressure bearing is kept inside the internal storage space of the bearing portion; a coil assembly disposed outside of the base portion and an impeller assembly. The dynamic pressure bearing comprises a shaft hole and a plurality of pressure collecting grooves arranged in an inner surface of the shaft hole at intervals. Furthermore lubricating oil is stored inside the pressure collecting grooves. Each pressure collecting groove has two slanted grooves extending slantways which connect with each other at one end to form a connecting point. A transverse groove extends from the connecting point backward the direction of the two slanted grooves. An impeller assembly includes an impeller, a magnet and a shaft and the magnet and the shaft are fixed in the impeller. The shaft is rotatably mounted in the shaft hole of the dynamic pressure bearing and the magnet is disposed close to the coil assembly.

The present invention also provides a dynamic pressure bearing structure. The dynamic pressure bearing structure includes a bearing portion having a internal storage space inside; a dynamic pressure bearing is kept in the storage space of the bearing portion and having a shaft hole; and a shaft rotatably mounted in the shaft hole of the dynamic pressure bearing. A plurality of pressure collecting grooves are arranged in an inner surface of the shaft hole at intervals. Furthermore lubricating oil is stored in the pressure collecting grooves. Each pressure collecting groove has two slanted grooves extending slantways which connect with each other at one end to form a connecting point. A transverse groove extends from the connecting point backward the direction of the two slanted grooves.

The present invention further provides a dynamic pressure bearing. The dynamic pressure bearing has a shaft hole and a plurality of pressure collecting grooves are arranged in an inner surface of the shaft hole at intervals. Each pressure collecting groove has two slanted grooves extending slantways which connect with each other at one end to form a connecting point. A transverse groove extends from the connecting point backward the direction of the two slanted grooves.

The efficacy of the present invention is as follows: the transverse groove extended from the connecting point of the two slanted grooves in the dynamic pressure bearing are provided to increase the area for creating pressure. Moreover the intensity of the pressure is improved and the number of pressure collecting grooves are decreased to reduce the processing load and production costs.

To further understand technical contents, methods and efficacy of the present invention, please refer to the following detailed description and drawings related the present invention. It is believed that the objects, features and points of the present invention can be deeply understood. However, the drawings are only to be used as references and explanations, not to limit the present invention.

### BRIEF DESCRIPTION OF THE DRAWINGS

FIG. 1 is a sectional view of a cooling fan in accordance with the present invention;

FIG. 2 is a perspective view of a dynamic pressure bearing of the cooling fan in accordance with the present invention;

FIG. 3 is a perspective view of the dynamic pressure bearing of the cooling fan in accordance with the present invention, without a shaft;

FIG. 4 is a sectional view of the dynamic pressure bearing of the cooling fan in accordance with the present invention; and

FIG. 5 is a sketched view simulating a flow field of the dynamic pressure bearing of the cooling fan in accordance with the present invention.

### DETAILED DESCRIPTION OF THE PREFERRED EMBODIMENTS

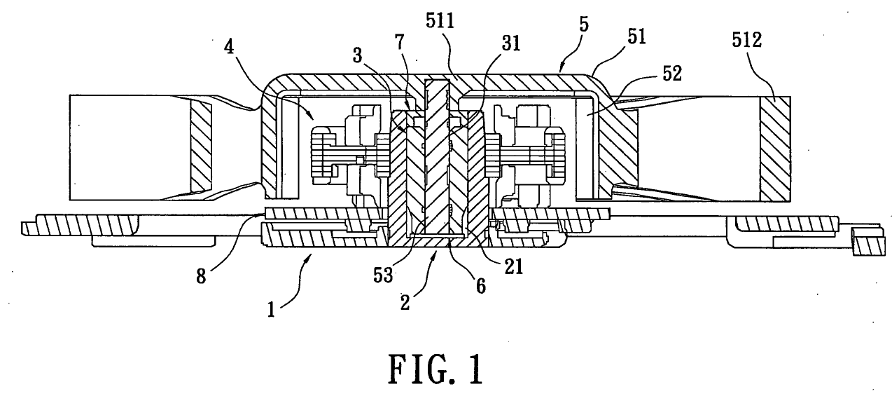

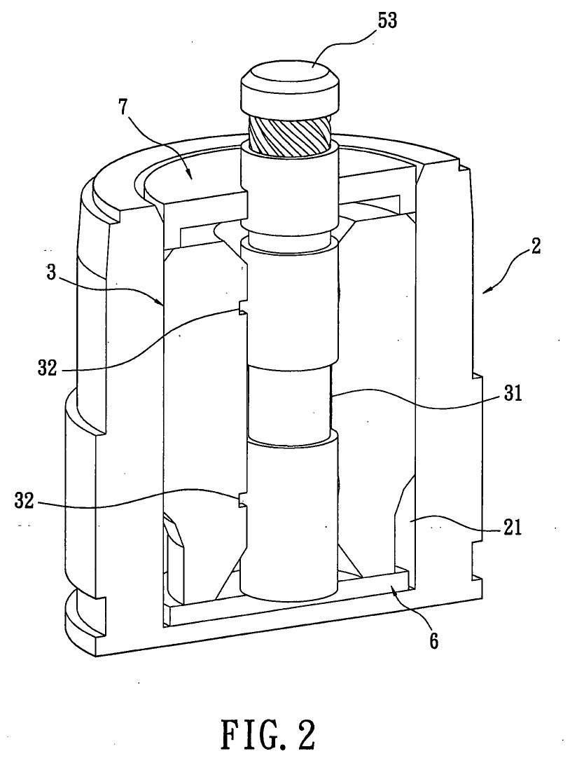

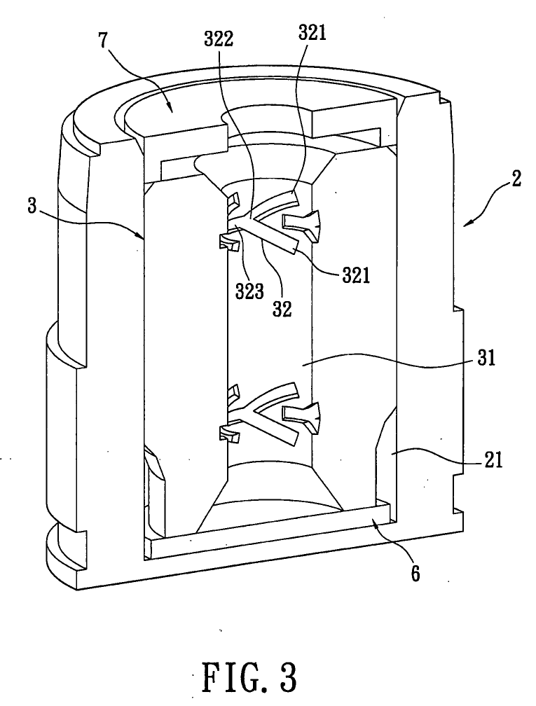

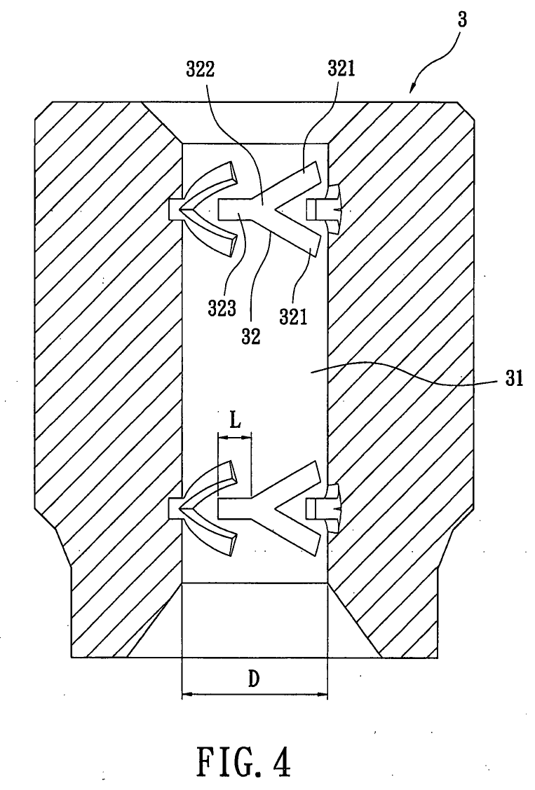

Please refer to FIGS. 1-4, a cooling fan in accordance with a preferred embodiment of the present invention is shown. The cooling fan includes a base portion 1, a bearing portion 2, a dynamic pressure bearing 3, a coil assembly 4, an impeller assembly 5, a gasket 6 and a cover for preventing oil leakages 7. The base portion is shaped approximately as a board for supporting the bearing portion 2, the dynamic pressure bearing 3, the coil assembly 4, the impeller assembly 5, and other elements.

The bearing portion 2 is formed as a hollow column and there is a internal storage space 21 inside and a top of which is shaped as an opening. The bottom of the bearing portion 2 fixed on the base portion 1 via an injection connection or a riveted joint.

The dynamic pressure bearing 3 is received in the internal storage space 21 of the bearing portion 2. An external surface of the dynamic pressure bearing 3 is tightly fixed in the internal storage space 21. There is a shaft hole 31 in a center oft he dynamic pressure bearing 3 and the hole penetrates through the dynamic pressure bearing 3 from top to bottom. A plurality of pressure collecting grooves 32 are concavely formed at upper and lower internal surface of the shaft hole 31 respectively to form two groups of pressure collecting grooves 32. Alternatively, the dynamic pressure bearing 3 can only dispose one group of pressure collecting grooves 32 (not shown). The pressure collecting grooves 32 are arranged at equal intervals for receiving lubricating oil. Each of the pressure collecting groove 32 has two slanted grooves 321 extending slantways. The two slanted grooves 321 are connected with each other to form a “<” shape with a connecting point 322. From the connecting point 322 a transverse groove 323 extends from the connecting point backward the direction of the two slanted grooves. The slanted grooves 321 and the transverse grooves 323 can be shaped as straight lines or curved lines.

Assuming that the number of each group of pressure collecting grooves 32 is N, the interior diameter of the dynamic pressure bearing 3 is D, and the length of the transverse groove 323 is L, a preferred embodiment of the present invention satisfies a formula as follows:

0<NL/πD<2/3.

The coil assembly 4 is mounted outside the bearing portion 2 and a circuit board 8 is disposed on the base portion 1 and the coil assembly 4 electrically connects with the circuit board 8 for controlling the coil assembly 4.

The impeller assembly 5 includes an impeller 51, a magnet 52 and a shaft 53. The impeller 51 has a hollow shell 511 with an open bottom. There are has a plurality of blades 512 disposed on an outer fringe of the shell 511 at intervals. The magnet 52 is a permanent magnet and shaped as a circular ring. The magnet 52 is fixed inside the shell 511. The shaft 53 is mounted in a center of the shell 511 and rotatably mounted in a shaft hole 31 of the dynamic pressure bearing 3 thereby the shaft 53 is rotatably pivoted on the coil assembly 4 via the dynamic pressure bearing 3. The shell 511 covers the bearing portion 2 and the coil assembly 4. The magnet 52 is disposed outside the coil assembly 4 and near the coil assembly 4 to keep a predetermined distance between an internal fringe of the magnet 52 and an external fringe of the coil assembly 4.

The gasket 6 is disposed on a bottom in the internal storage space 21 of the bearing portion 2 to keep a bottom of the shaft 53 colliding with a top of gasket 6. The cover for preventing oil leakages 7 covers the top of the internal storage space 21 and seals the internal storage space 21 for preventing the lubricating oil in the bearing portion 2 from leakage. The cover for preventing oil leakages 7 is optional and based upon the situation in which the product is used. According to the above components and structure, the cooling fan in accordance with a preferred embodiment of the present invention is formed.

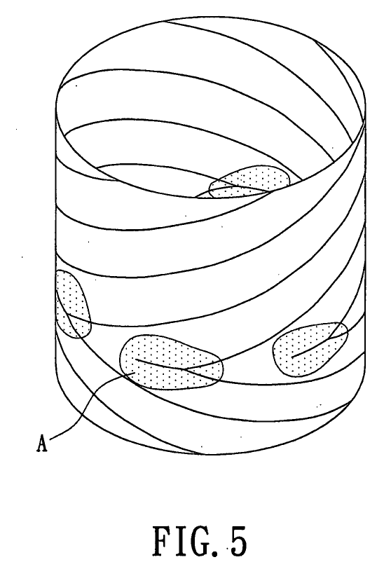

When the impeller assembly 5 starts operating, the lubricating oil flows along the two slanted grooves 321 of the pressure collecting grooves 32 and is centralized into the connecting point 322 and the transverse groove 323 to form a high pressure area A (as shown in FIG. 5). High pressure is produced for isolating the shaft 53 from the dynamic pressure bearing 3 in order to avoid friction between the shaft 53 and the dynamic pressure bearing 3. Moreover, the acoustic noise is also reduced.

The present invention increases the area creating pressure and higher pressure intensity than the prior art is exerted via the arrangement of the transverse groove 323. Thereby the present invention decreases the number of pressure collecting grooves 32 to reduce the processing load and production costs.

Moreover, depending on the arrangement of the cover for preventing oil leakages 7, the present invention reduces leakage of the lubricating oil and increases the serviceable lifetime of the shaft 53 and the dynamic pressure bearing 3, and further reduces the friction area and the friction coefficient to lower noise caused by friction.

Additionally, besides used in cooling fans, the dynamic pressure bearing of the present invention can be applied in pumps, motors, etc.

What is disclosed above is only the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A cooling fan, comprising:
a base portion;
a bearing portion, having a internal storage space inside and mounted on the base portion;
a dynamic pressure bearing, received in the internal storage space of the bearing portion and having a shaft hole, a plurality of pressure collecting grooves arranged in an inner surface of the shaft hole at intervals for receiving lubricating oil, each having two slanted grooves extending slantways and connecting with each other at one end to form a connecting point, a transverse groove extending from the connecting point backward the direction of the two slanted grooves;
a coil assembly, mounted outside of the bearing portion; and
an impeller assembly, including an impeller, a magnet and a shaft, the magnet and the shaft mounted in the impeller, the shaft rotatably mounted in the shaft hole of the dynamic pressure bearing and the magnet set near the coil assembly.

2. The cooling fan as claimed in claim 1, wherein the base portion has a circuit board mounted thereon, and the circuit board electrically connects with the coil assembly.

3. The cooling fan as claimed in claim 1, wherein a gasket is mounted on a bottom in the internal storage space of the bearing portion and a bottom of the shaft of the impeller assembly collides with the gasket.

4. The cooling fan as claimed in claim 1, wherein a top of the internal storage space of the bearing portion is shaped like an opening and is covered by a cover for preventing oil leakages.

5. The cooling fan as claimed in claim 1, wherein the pressure collecting grooves are arranged at an upper portion and a lower portion in the inner surface of the shaft hole.

6. The cooling fan as claimed in claim 1, wherein the slanted grooves are shaped like straight lines or curved lines.

7. The cooling fan as claimed in claim 1, wherein the transverse groove is shaped like a straight line or a curved line.

8. The cooling fan as claimed in claim 1, wherein the dynamic pressure bearing satisfies a formula as follows:
0<NL/πD<2/3
Wherein N: the number of the pressure collecting grooves,
D: the interior diameter of the dynamic pressure bearing, and
L: the length of the transverse groove.

9. The cooling fan as claimed in claim 1, wherein the impeller of the impeller assembly has a shell, a plurality of blades are disposed on an external fringe of the shell, the magnet is mounted inside the shell and the shaft is mounted in a center of the shell.

10. A dynamic pressure bearing structure, comprising:
a bearing portion, having an internal storage space inside;
a dynamic pressure bearing, received in the internal storage space of the bearing portion and having a shaft hole, a plurality of pressure collecting grooves arranged in an inner surface of the shaft hole at intervals for receiving lubricating oil, each having two slanted grooves extending slantways connecting with each other at one end to form a connecting point, a transverse groove extends from the connecting point backward the direction of the two slanted grooves; and
a shaft, rotatably mounted in the shaft hole of the dynamic pressure bearing.

11. The dynamic pressure bearing structure as claimed in claim 10, wherein a gasket is mounted on a bottom in the internal storage space of the bearing portion and a bottom of the shaft collides with the gasket.

12. The dynamic pressure bearing structure as claimed in claim 10, wherein a top of the internal storage space of the bearing portion is shaped like an opening and is covered by a cover for preventing oil leakages.

13. The dynamic pressure bearing structure as claimed in claim 10, wherein the pressure collecting grooves are arranged at an upper portion and a lower portion in the inner surface of the shaft hole.

14. The dynamic pressure bearing structure as claimed in claim 10, wherein the slanted grooves are shaped like straight lines or curved lines.

15. The dynamic pressure bearing structure as claimed in claim 10, wherein the transverse groove is shaped like a straight line or a curved line.

16. The dynamic pressure bearing structure as claimed in claim 10, wherein the dynamic pressure bearing satisfies a formula as follows:
0<NL/πD<2/3
Wherein N: the number of the pressure collecting grooves,
D: the interior diameter of the dynamic pressure bearing, and
L: the length of the transverse groove.

17. A dynamic pressure bearing, comprising a shaft hole, a plurality of pressure collecting grooves arranged in an inner surface of the shaft hole at intervals and each having two slanted grooves extending slantways connecting with each other at one end to form a connecting point, a transverse groove extends from the connecting point backward the direction of the two slanted grooves.

18. The dynamic pressure bearing as claimed in claim 17, wherein the pressure collecting grooves are arranged at an upper portion and a lower portion in the inner surface of the shaft hole.

19. The dynamic pressure bearing as claimed in claim 17, wherein the slanted grooves are shaped like straight lines or curved lines.

20. The dynamic pressure bearing as claimed in claim 17, wherein the transverse groove is shaped like a straight line or a curved line.

21. The dynamic pressure bearing as claimed in claim 17, satisfying a formula as follows:
0<NL/πD<2/3
Wherein N: the number of the pressure collecting grooves,
D: the interior diameter of the dynamic pressure bearing, and
L: the length of the transverse groove.
